(19) United States
(12) Patent Application Publication
(10) Pub. No.: US 2018/0329873 A1
(43) Pub. Date: Nov. 15, 2018

(54) AUTOMATED DATA EXTRACTION SYSTEM BASED ON HISTORICAL OR RELATED DATA

(71) Applicant: Google Inc., Mountain View, CA (US)

(72) Inventors: Dmitry Butyugin, IV, Adliswil (CH); Milan Mitrovic, Zurich (CH); Marko Ivankovic, Wettswil am Albis (CH)

(21) Appl. No.: 14/682,071

(22) Filed: Apr. 8, 2015

(51) Int. Cl. G06F 17/22; G06F 17/21

(52) U.S. Cl. CPC G06F 17/2247; G06F 17/211

(57) ABSTRACT

A system and method for data extraction from structured documents using historical or related data. Structured documents are searched for instances of an attribute value that match a known historical value for the attribute. Document features associated with the attribute value are identified and anchor a location within the hierarchy of the document structure where the attribute value can be found and extracted. An accuracy for the identified anchors is determined by evaluating how well the anchor's extraction history matches the reported history. Anchors are grouped into anchor sets such that all anchors in a set extract attributes from the same structured document template. The anchors are prioritized according to the determined accuracy, the prioritized list defining the order in which a structure document template should be searched for an attribute value.

### TECHNICAL FIELD

The present disclosure relates generally to data extraction from structured documents and, more particularly, to data extraction from structured documents where the template of the structured document is unknown and both the template and content of the structure document are likely to change over time.

### BACKGROUND

Content aggregators accept structured documents from data content providers. The structure of the document and the content of the document can change over time. In addition, data providers may provide incorrect data in some portion of the documents provided to content aggregators. For example, a shopping search engine receives web pages of online merchants, or links to landing pages thereto, that contain information on products the merchant offers for sale. In order to display relevant search results and do product ranking, the shopping search engine requires knowledge of product attributes such as current price, product identifier, and availability. The challenge is to make sure the information provided by the content aggregator accurately reflects the latest information from the data content provider.

There are three general approaches to solving the problem of assessing the quality of data collected by the data aggregator from data content providers. Manual review of landing pages by human reviewers would allow the attributes and attribute values of interest to be extracted. However, this is a very expensive solution when the amount of data to be reviewed is high and suffers from the limited scalability of manual review. Alternatively, a series of scripts could be written in a programming language that are designed to extract desired attributes from the documents of the data content providers. For example, scripts could be written to extract price, availability and product identifiers, or other information from the landing pages of specific merchants. This approach also suffers from a scalability issues as each individual merchant or aggregator of merchants must be covered separately. Another approach could involve extracting metadata provided in annotations on landing pages using a standard metadata micro-format. However, the data must be added by the data content providers and may still fail to provide the most up to date or accurate information. Accordingly, there is a need in the art for automated data extraction methods and systems that do not require existing knowledge of the internal structure of a document, are readily scalable to handle large amounts of data, and do not require the coordinated modification of document structure by data content providers to include special markers such as metadata.

### SUMMARY

In certain example embodiments described herein, a method for extracting data from structured documents based on historical attribute data comprises receiving one or more structured documents from a data content provider, identifying one or more instances of an attribute value in the structured document that matches a known past value for the attribute, identifying one or more anchors associated with each identified instance of the attribute value, determining an accuracy of the identified anchors, grouping the identified anchors into an anchor set where each anchor in the anchor set extracts attribute values from the same structured document template, and generating a prioritized anchor set where each anchor is ranked according to the anchor's accuracy, the ranking defining an order in which document elements of a structured document template should be searched to identify the desired attribute.

In certain other example embodiments described herein, a system and computer program product for extracting data from structured documents based on historical attribute data are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for extracting data from a document template of unknown structure using historical or related data, in accordance with certain example embodiments.

FIG. 2 is a block flow diagram depicting a method to extract data from a document template of unknown structure using historical or related data, in accordance with certain example embodiments.

FIG. 3 is a block flow diagram depicting a method to identify one or more anchors in document templates of unknown structure, in accordance with certain example embodiments.

FIG. 4 is a block diagram depicting a computing machine and a module, in accordance with certain example embodiments.

### DETAILED DESCRIPTION OF THE EXAMPLE EMBODIMENTS

### Overview

The embodiments described herein provide a system and method for data extraction from documents templates using historical or related data. Prior knowledge of the document template structure is not required. The system receives document templates containing various data from data content providers. For a given data aggregator, a certain portion of that data may be of interest. Accordingly, the challenge is to identify and accurately extract the data of interest from documents that will vary in template structure and content over time. In certain example embodiments, a data aggregator is an online service that seeks to identify and summarize certain types of data, the original data being obtained from different data content providers who provide the data in varied document template formats.

The system and methods described herein use historical or relevant data for attribute values to find the most prominent locations in a given document template where the desired attribute value can be found and extracted. For example, in the context of a shopping search engine data aggregator, if the price for item A was previously known to be $100, then the system will search for all instances of “100” in the structured document templates received from merchant data content providers. Document elements that appear proximate to the attribute value are used to anchor or identify these locations in a given structured document template. In certain example embodiments, a structured document template is an electronic file format comprising document elements that are syntactically distinguishable from the data contained in the structured document template. For example, a document element may comprise tags used in mark-up language file formats or headers and similar formatting in word processing, spreadsheet, and portable document file formats.

The identified anchors then undergo a generalization phase during which similarities between different anchors are identified. If two or more anchors are found to identify the same document elements in a document structure, the anchors are merged together such that they will identify the same elements in the document as the original anchors. The accuracy of each anchor is then assessed by applying the anchors to a subset of documents for which the history of a given attribute value is known.

Anchors that cover a given document template are joined to form an anchor set and ranked according to their accuracy. In certain example embodiments, the anchor rank defines the order in which the corresponding document template should be searched for the attribute value. The ranked list of anchors is stored and can be used to extract the attribute values from new structured documents as they are received from the data content providers. The system can be used by content aggregators to assess the quality of data values provided by the data content providers and to exclude content with erroneous data from being served.

By using and relying on the methods and systems described herein, the data extraction system can use the existing structure of a new or newly modified structured document template to identify and extract the desired data. As such, the system does not require modification of the document template or the inclusion of any special markers to identify the data to be extracted. Further, the system does not require manual efforts thereby allowing the processing of a high volume of electronic documents automatically. Hence, the system and method provides reduced cost and maintenance over data extraction systems that require the writing and/or updating of scripts for each document template to be analyzed. Because the anchors are detected automatically minimal cost is required to expand coverage by the system to include new structured document templates as they become available, or as existing structured document templates are modified over time.

Turning now to the drawings, in which like numerals represent like (but not necessarily identical) elements throughout the figures, example embodiments are described in detail.

### Example System Architectures

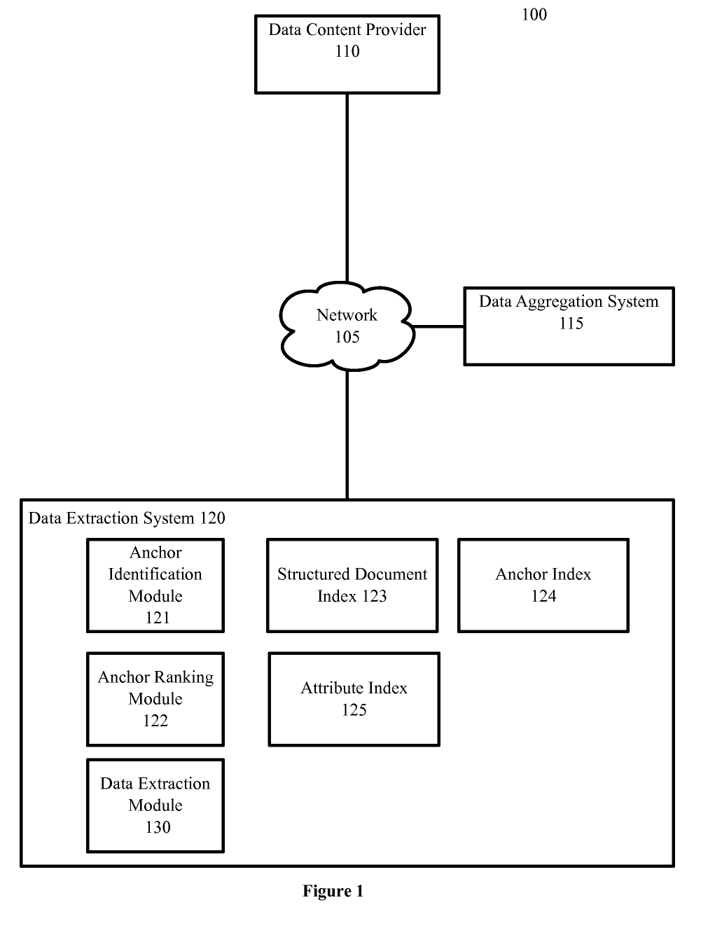

FIG. 1 is a block diagram depicting a system for extracting data from a structured document template using historical or related data, in accordance with certain example embodiments. As depicted in FIG. 1, the system 100 includes network devices 110, 115, and 120 that are configured to communicate with one another via one or more networks 105. In some embodiments, a user associated with a device must install an application and/or make a feature selection to obtain the benefits of the techniques described herein.

The network 105 includes a wired or wireless telecommunication system or device by which network devices (including devices 110, 115 and 120) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer based environment.

Each network device 110, 115, and 120 includes a device having a communication module capable of transmitting and receiving data over the network 105. For example, each network device 110, 115 and 120 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices (including devices 110, 115, and 120) are operated by data content operators (not depicted), data aggregation system operators (not depicted) and data extraction system operators, respectively.

It will be appreciated that the network connections shown are example and other means of establishing a communications link between the computers and devices can be used. Moreover, those having ordinary skill in the art having the benefit of the present disclosure will appreciate that the data content provider 110, data aggregation system 115, and data extraction system 120 illustrated in FIG. 1 can have any of several other suitable computer system configurations.

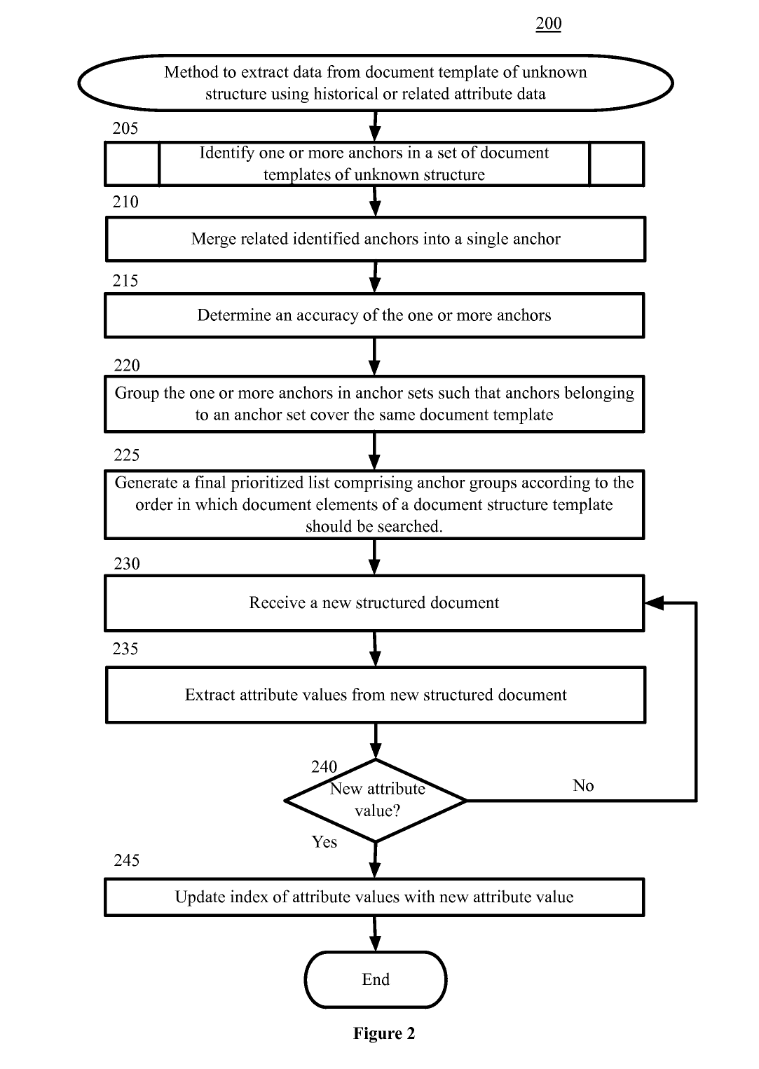

In example embodiments, the network computing devices and any other computing machines associated with the technology presented herein may be any type of computing machine such as, but not limited to, those discussed in more detail with respect to FIG. 1. Furthermore, any modules associated with any of these computing machines, such as modules described herein or any other modules (scripts, web content, software, firmware, or hardware) associated with the technology presented herein may by any of the modules discussed in more detail with respect to FIG. 1. The computing machines discussed herein may communicate with one another as well as other computer machines or communication systems over one or more networks, such as network 105. The network 105 may include any type of data or communications network, including any of the network technology discussed with respect to FIG. 2.

### Example Processes

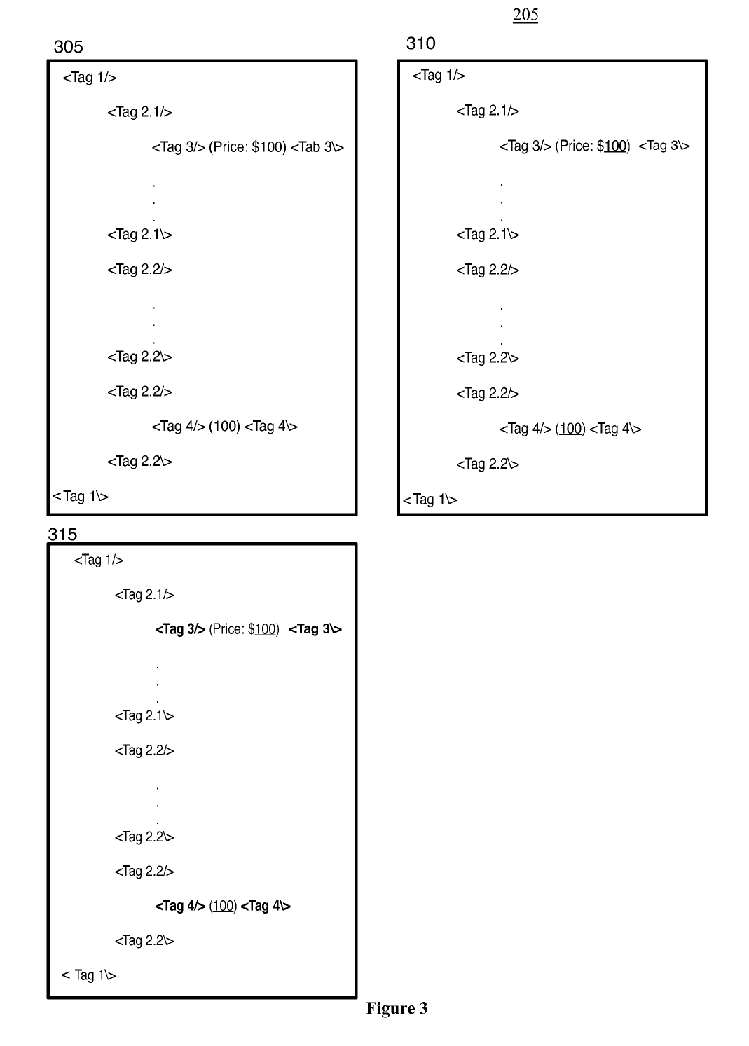

The example methods illustrated in FIGS. 2-3 are described hereinafter with respect to the components of the example operating environment 100. The example methods of FIGS. 2-3 may also be performed with other systems and in other environments.

FIG. 2 is a block flow diagram depicting a method 200 to extract data from structured document templates using historical or related data, in accordance with certain example embodiments.

Method 200 begins at block 205, where one or more anchors are identified in a set of structured documents. Method 205 will be described in further detail with reference to FIG. 3.

FIG. 3 is a diagram depicting a method 205 to identify one or more anchors in a set of structured documents. Method 205 begins at block 305, where the anchor identification module 121 receives a structured document 305 or set of structured documents containing data from a data content provider 110. For example, the host server of a web site may publish or make available the web pages of the web site to the data extraction system 120. The anchor identification module 121 may receive a copy of the structured documents, or links to the structured documents, directly from the data content provider 110, or in the case of published web pages, the anchor identification module 121 may crawl the structured documents at regularly defined intervals. Any structured document that comprises document elements that are syntactically distinguishable from the data contained in the structured document may be analyzed by the data extraction system 120. In certain example embodiments, the structured document is a mark-up language document. Example mark-up languages include, but are not limited to, HTML, XML, XHTML, RDF/XML, XForms, DocBook, SOAP, and OWL. In certain example embodiments, the structured document is in a word processing file format generated using word processing software such as Google Docs®, Microsoft Word®, and Apple Pages®. In certain example embodiments, the structured document may be a spreadsheet document such as those generated using software such as Microsoft Excel®, Apple Numbers®, and Google Sheets®. In certain other example embodiments, the structured document may be in a portable document format (.pdf), or similar format. For ease of reference, the remaining steps will discussed in the context of a data extraction system 120 that functions as a shopping aggregator system that extracts data from online catalog web pages of various merchants written in a mark-up language. However, the structured documents may contain any content and may be any structured document as defined above. A shopping aggregator system 120 may extract product attributes from merchant web pages and then display the relevant product attribute information, along with a link to the corresponding merchant or merchants web sites, in response to a search engine query by a user. The online catalogs received from the merchants may comprise one or more web pages listing the various items a merchant offers for sale. As can be appreciated, the mark-up language code used to define each web page (i.e. structured document) will vary from one merchant to the next, and can even vary from page to page for a given merchant. For example, the mark-up language code defining an online catalog page for clothing may be arranged differently than the mark-up language code defining an online catalog page for home furnishings offered by the same merchant. Likewise, mark-up language code defining a page featuring a merchant's special or sale offers may be different from the mark-up language code defining a standard web catalog page.

At block 310, the anchor identification module 121 identifies all instances in the received structured document that match a desired attribute value. For example, the shopping aggregator system 120 may require knowledge of certain product attributes, such as current price, a product identifier, such as a global trade item number (GTIN), and availability, to do a proper product ranking. For each merchant, there is historical data on the attribute values of interest. For example, the price of particular items for sale may be known from prior data extractions by the data extraction system 120. For at least a portion of those attributes, the historical attribute values will remain unchanged in the current set of merchant structured documents. Therefore, the known historical data for the price of an item may then be used to identify instances of that attribute in the structured documents. For example, if the price of a product is known to have recently been listed at $100, the anchor identification module will search the structured document for all instances of the value “100” (show in underline in block 310). In certain examples, the identified instance may be associated with the desired attribute such as at “Tag 3” in example document 310. Alternatively, the identified instance may not be related to the desired attribute such as at “Tag 4” in example document 310. For example, “Tag 4” could relate to address information or a telephone number. The anchor identification module 121 may obtain the known attribute value from a structured document index 123 or separate attribute index 125 containing historical or related data for the attribute value. In certain example embodiments, the structured document index 123 contains previously received structured documents. In certain example embodiments, the structured documents may be arranged in the structured document index 123 by data content provider 110.

At block 315, the anchor identification module 121 relies on the internal structure of the structured documents to anchor the locations where all instances of the desired attribute value are identified (show in bold in block 315). The anchors represent a path in the hierarchy of the document structure that identifies one or more document elements associated with the attribute value. In example structured document 315, the document elements are “Tag 3” and “Tag 4.” The identified anchors and the structured document template to which they belong are stored in an anchor index 124 for further processing. Note at this stage of the method, all anchors are at least temporarily stored. Those anchors not associated with the desired attribute will be discarded as the method proceeds and as described further below.

Returning to block 210 of FIG. 2, the anchor identification module 121 groups anchors that define similar paths in the hierarchy of document structure such that all similar anchors are merged together. This step keeps the number of active anchors small and extends the applicability of an anchor to more than one structured document template. In certain example embodiments, each identified anchor is merged with another identified anchor. If the merged anchor produces the same result as the individual anchor the anchors remain merged. However, if the merged anchor produces different results from the individual anchor, then the merged anchor is discarded an each individual anchor is retained. The method then proceeds to block 215.

At block 215, the anchor ranking module 122 determines an accuracy of the identified anchors. In certain example embodiments, the anchor ranking module 122 determines the accuracy of the identified anchors on a subset, or test set, of structured documents for which the attribute values are known. For example, the known attribute values may be those attribute values stored in the attribute index 125 from prior assessments obtained using method 200. It should be noted, the attribute value may not necessarily be the same as that used to initially identify the anchor. The identified anchor is either associated with price attributes or it is not. The identified anchor can be used to extract any price attribute value on the known page. If the identified anchor is associated with a price attribute it will extract and return the correct price. If the identified anchor is associated with another attribute type it will not extract the correct attribute value. The process may be repeated on multiple pages and those anchors that extract the correct attribute value with the desired level of accuracy are retained and those below an accuracy threshold are discarded.

In certain example embodiments, the anchor ranking module 122 determines the accuracy, at least in part, by determining how frequently the anchor extracts the correct attribute value from a test set of structured document templates with known attribute values. For example, the anchor ranking module 122 searches the test set using the anchors identified in block 210 and extracts the attribute value identified by each anchor. The anchor ranking module 122 then determines if the attribute value extracted using the anchor is the correct attribute value by comparing it to the known attribute value from the corresponding test set document. In certain example embodiments, an accuracy for the anchor is defined by the number of times the anchor extracts the correct attribute value over the total number of extractions attempted. The minimum number of extractions that must be attempted before an accuracy is determined is a configurable parameter of the system. In certain example embodiment, a total of about 10, about 25, about 50, about 75, about 100, about 500, or about 1000 extractions is required. In certain example embodiments, an accuracy threshold may be defined such that any anchor that does not achieve an accuracy rating higher than the accuracy threshold is discarded. In certain example embodiments the accuracy threshold is equal to or greater than 20%, 30%, 40%, 50%, 60%, 70%, 80%, 90%, or 95%. In certain other example embodiments, the accuracy threshold is equal to 60%. In certain other example embodiments, the accuracy threshold is greater than 60%.

At block 220, the anchor ranking module 122 groups the identified anchors into anchor groups such that anchors belonging to an anchor group cover the same document template. For example, all anchors that identify attributes from the online catalog page of Merchant X would be grouped into an anchor set. In some instances, the data content provider 110 may use the same template for all pages of the same class. For example, a merchant with a “men's” “women's,” and “children's” section may use the same mark-up language for each web catalog page. Alternatively, the data content provider 110 may use many different document templates for each section or class of pages. An anchor group will identify the location of attributes in the same document template. Therefore in certain example embodiments, a single anchor set may cover all document templates used by a data content provider 110. In other example embodiments, several anchor sets may be needed to cover all document templates used by a given data content provider 110. In yet other example embodiments, an anchor set may cover documents templates from different data content providers 110 that use the same general document template format.

The anchor ranking module 122 may use different criteria to group any two anchors into an anchor set. In one example embodiment, anchors are placed in the same group if there is a non-empty set of structured documents from which each anchor extracts an attribute. In certain example embodiments, the non-empty set is the test set. In another example embodiment, anchors are grouped in an anchor set if they extract different values from the same set of documents. In another example embodiment, anchors are included in an anchor set if all anchors extract an attribute and one or more of the anchors perform consistently better than the other anchors for that attribute value. In certain other example embodiments, anchors are included in an anchor set if a first anchor provides good extraction results on a set of documents, from which a second anchor does not extract any values for that particular attribute value. In certain example embodiments, a combination of two or more of the above criteria are used to define anchor groups. In certain example embodiments, the anchor set comprises 2-10 anchors, 2-20 anchors, 2-50 anchors, 2-75 anchors, or 2-100 anchors, or any sub-combination in between.

An operator of the data extraction system 120 may select the criteria depending on the attribute type to be extracted. For example, the criteria where anchors are grouped if they extract different values from the same document template performs well to extract both a base price and sale price(s), and also to handle situations where the price has been converted from a foreign currency. In certain example embodiments, the distinction between base price and sale price is based on which anchor in an anchor set performs consistently better (i.e. is more often correct) instead of the anchor that identifies the lowest price. This allows for coverage of conversion from foreign currencies where the converted sale price might be greater. The anchor ranking module 122 stores the anchor groups in the anchor index 124. In certain example embodiments, the anchor sets are stored in the anchor index 124 by data content provider 110, for example, by merchant. The method then proceeds to block 225.

At block 225, the anchor ranking module 122 ranks each anchor in an anchor set by the anchor's accuracy score determined in block 215, such that the anchor with the highest accuracy rating is ranked first and so on. The ranking of the anchors defines a specific order in which the corresponding document template should be checked for the attribute value. Accordingly, for a given structured document template, the document will first be searched for attribute values located at the position defined by anchor 1, then searched for attribute values located at the position defined by anchor 2 and for all other remaining anchors in the group. The ranking modules updates the order of the anchor group in the anchor index 124. The prioritized anchor sets may now be used to extract data from new structured documents as they are received from the data content providers 110.

At block 230, the data extraction module 130 receives a new or updated set of structured documents from a data content provider 110. For example, the data extraction module 130 may crawl web pages of data content providers 110 at regular intervals. In certain example embodiments, the data extraction module 130 receives structured documents every 24 hours, every 12 hours, or every 3 hours.

At block 235 the data extraction module 130 extracts attribute values from the received structure documents using the corresponding prioritized anchor groups defined in blocks 220-225 above. In certain example embodiments, if a new structured document is received that does not have a corresponding anchor set, then the data extraction module 130 may communicate the structured document or documents to the anchor identification module 121 for processing according to blocks 205-225. In certain example embodiments, each anchor set may extract multiple attribute values or it may extract only a single attribute value. The attribute values extracted will depend on the needs of the data aggregation system 115. In certain example embodiments, the data extraction system 120 and the data aggregation system 115 are components of the same system. In one example embodiment, the data aggregation system 115 is a shopping search engine and the attribute values extracted comprise at least an active price, product identifier, and availability.

At block 240, the data extraction module 130 determines if the extracted attribute values are new attribute values compared to what is stored in the structured document index 123 or optional attribute index 125.

If the extracted attribute values are the same as the existing attribute values, the method proceeds to block 230 and awaits receipt of additional structured documents.

Returning to block 240, if the data extraction module 130 determines the extracted attribute is different from the existing attribute value, then the method proceeds to block 245.

At block 245, the data extraction module 130 replaces the existing attribute value in the structured document index 123 or attribute index 125 with the new extracted attribute value. The attribute information stored in the structured document index 123 or attribute index 125 may then be used by the data extraction system 120 or a data aggregation system 115 to provide current attribute information in response to a search query. For example, in the context of the shopping aggregator system, the shopping aggregator system 115 can provide a list of products and corresponding product attributes for display to a user in response to a search query from that user. For example, if the user searched for a particular type of athletic shoe, the shopping aggregator system 115 can provide information on merchants where that type of athletic shoe may be purchased along with current pricing information and other product attribute information.

### Other Example Embodiments

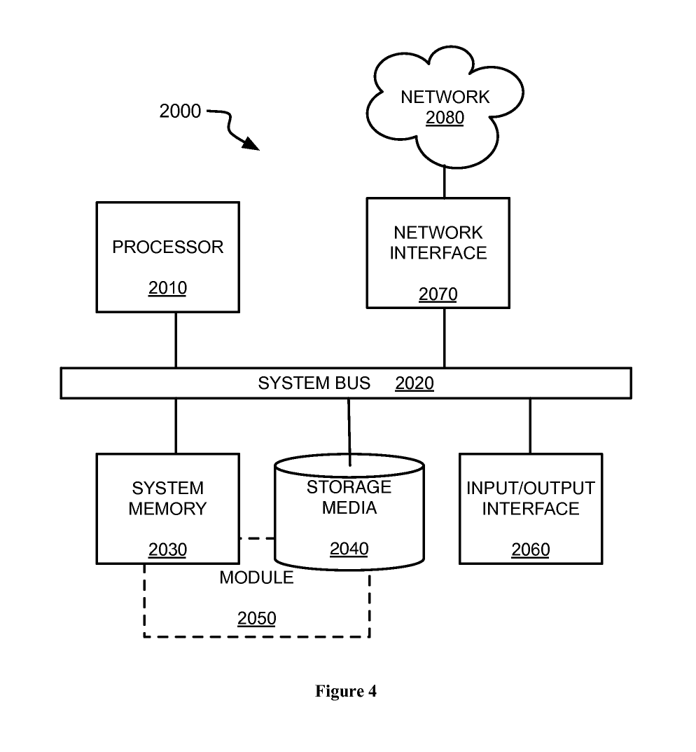

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to extract data from structured documents using historical or related data, comprising:
receiving, by one or more computing devices, a structured document from a data content provider;
identifying, by the one or more computing devices, one or more instances of an attribute value in the structured document that matches a known past value for the attribute;
identifying, by the one or more computing devices, an anchor associated with each identified instance of the attribute value, the anchor comprising one or more document elements in association with the attribute value;
extracting, by the one or more computing devices, using the anchor, an attribute value from a test set of structure document templates with known attribute values;
determining, by the one or more computing devices, an accuracy of the anchor, wherein the accuracy is determined at least in part by determining how frequently the anchor extracts a correct attribute value from the test set of structured document templates with known attribute values, wherein a predetermined minimum number of extractions are attempted before an accuracy of the anchor is determined;
removing, by the one or more computing devices, an anchor from the identified anchors if the accuracy of that anchor is below an accuracy threshold value;
grouping, by the one or more computing devices, the identified anchors that are not below the accuracy threshold value into an anchor set such that anchors belonging to a same anchor set extract attribute values from a common structured document template; and
generating, by the one or more computing devices, prioritized anchor sets, wherein the anchors in each prioritized anchor set are ranked according to the determined accuracy of each anchor, the ranking defining an order in which document elements of a structured document template should be searched to identify the desired attribute value.

2. The method of claim 1, further comprising
extracting, by the one or more computing devices, attribute values from a new set of structured documents using the prioritized anchor sets;
comparing, by the one or more computing devices, the extracted attribute values to existing attribute values stored in an attribute index; and
updating, by the one or more computing devices, the existing attribute values in the attribute index if the extracted attribute values are different from the existing attribute values.

3. (canceled)

4. The method of claim 1, wherein the set of structured documents comprises mark-up language documents.

5. The method of claim 1, wherein the one or more anchors identifying similar document elements in the structured documents are merged into a single anchor.

6. (canceled)

7. The method of claim 1, wherein one or more anchors are grouped in an anchor set if there is a non-empty set of structured documents from which each of the one or more anchors extract attribute values, one anchor has a higher accuracy on the test set of structured documents than other anchors that extract attribute values from the test set, one anchor has a high accuracy on the test set of structured documents and another anchor does not extract a attribute value from the test set of structured documents, each anchor extracts a different value from the test set of structured documents, or a combination thereof.

8. The method of claim 1, wherein the data content provider is a merchant and the one or more structured documents comprise mark-up language versions of an online catalog of the merchant.

9. The method of claim 1, wherein the attribute value comprises at least a price value.

10. A computer program product, comprising:
a non-transitory computer-readable storage device having computer-executable program instructions embodied thereon that when executed by a computer cause the computer to extract data from structured documents using historical or known data, comprising:
computer-executable program instructions to identify one or more instances of an attribute value in a structured document received from a data content provider that matches a known past value for the attribute;
computer-executable program instructions to identify an anchor associated with each identified instance of the attribute value, the anchor comprising one or more document elements in the structured document associated with the attribute value;
computer-executable program instructions to extract, using the identified anchor, an attribute value from a test set of structure document templates with known attribute values;
computer-executable program instructions to determine an accuracy of the anchor, wherein the accuracy is determined at least in part by determining how frequently the anchor extracts a correct attribute value from the test set of structured document templates with known attribute values, wherein a predetermined minimum number of extractions are attempted before an accuracy of each identified anchor is determined;
computer-executable program instructions to remove an anchor if the accuracy of that anchor is below an accuracy threshold value;
computer-executable program instructions to group the identified anchors into an anchor set such that anchors belonging to a common anchor set cover a common structured document template;
computer-executable program instructions to generate a prioritized anchor set, wherein the anchors in each prioritized anchor set are ranked according to the determined accuracy of each anchor, the ranking defining an order in which document elements of a structured document template should be searched to identify the desired attribute value;
and
computer-executable program instructions to extract the attribute value from a set of new structured documents received from data content providers.

11. The computer program product of claim 10, the computer-executable program instructions further comprising:
computer-executable program instructions to compare the extracted attribute values to existing attribute values stored in an attribute index; and
computer-executable program instructions to update the existing attribute values in the attribute index if the extracted attribute values do not match in the existing attribute values.

12. The computer program product of claim 10, wherein the set of structured documents comprises mark-up language documents.

13. The computer program product of claim 10, wherein the structured document is in a word processing file format, a portable document file format, or a spreadsheet file format.

14. The computer program product of claim 10, wherein one or more anchors that identify common document elements are merged into a single anchor.

15. The computer program product of claim 10, wherein the one or more anchors are grouped in an anchor set, wherein all anchors in the anchor set extract attributes values from a common structured document template.

16. The computer program product of claim 10, wherein the data content provider is an online merchant and the structured document is a mark-up language document comprising online catalog information of the merchant.

17. The computer program product of claim 10, wherein the attribute value comprises at least a price value.

18. A system to extract data from structured documents using historical or related data, comprising:
a storage device; and
a processor communicatively coupled to the storage device, wherein the processor executes application code instructions that are stored in the storage device to cause the system to:
receive a structured document or set of structured documents from a data content provider;
identify one or more instances of an attribute value in the structured document that matches a known past value for the attribute;
identify an anchor associated with each identified instance of the attribute value, the anchor comprising a document element in the one or more structured documents associated with the attribute value;
extract, using the anchor, an attribute value from a test set of structure document templates with known attribute values;
determine an accuracy of each identified anchor, wherein the accuracy is determined at least in part by determining how frequently the identified anchor extracts a correct attribute value from the test set of structured document templates with known attribute values, wherein a predetermined minimum number of extractions are attempted before an accuracy of each identified anchor is determined;
remove an anchor from the identified anchors if the accuracy of that anchor is below an accuracy threshold value;
generate prioritized anchor sets, wherein the anchors in each anchor set extract attributes from a common document template, each anchor in the anchor set ranked according to the determined accuracy of each anchor, the ranking defining an order in which document elements of a new structured document template should be searched to identify the desired attribute value.

19. The system of claim 18, wherein the processor executes further application code instruction that cause the system to:
extract attribute values from a new set of structured documents received from data content providers using the anchor sets;
compare the extracted attribute values to existing attribute values stored in an attribute index; and
update the existing attribute values in the attribute index if the extracted attribute value is different from the existing attribute value.

20. The system of claim 18, wherein one or more anchors are grouped in an anchor set if there is a non-empty set of structure documents from which each of the one or more anchors extract attribute values, one anchor has a higher accuracy than the other anchors on the test set of structured documents, one anchor has a high accuracy on the test set of structured documents and another anchor does not extract a attribute value from the test set of structured documents, each anchor extracts a different value from the test set of structured documents, or a combination thereof.

21. The system of claim 18, wherein the one or more anchors identifying similar document elements in the one or more structured documents are merged into a single anchor.
